(19) United States
(12) Patent Application Publication
(10) Pub. No.: US 2023/0013261 A1
(43) Pub. Date: Jan. 19, 2023

(54) ARTIFICIAL REEF FOR COASTAL PROTECTION

(71) Applicant: CCELL RENEWABLES LIMITED, London (GB)

(72) Inventors: William John Douglas BATEMAN, London (GB); Dolores GONZALEZ OLIAS, Madrid (ES); Samuel UDELMAN LEON, Madrid (ES)

(21) Appl. No.: 17/865,212

(22) Filed: Jul. 14, 2022

(30) Foreign Application Priority Data
Jul. 15, 2021 (GB) 2110232.2
Jun. 24, 2022 (GB) 2209302.5

(51) Int. Cl. A01K 61/73; E02B 3/06

(52) U.S. Cl. CPC A01K 61/73; E02B 3/06

(57) ABSTRACT

A module for an artificial reef is substantially in the shape of a continuous arch and is formed as a skeletal framework comprising a plurality of spaced apart transverse beams that each define a portion of the arch, and a plurality of longitudinal beams attached to the transverse beams and extending the length of the arch. The longitudinal beams provide a barrier to waves when one or more modules are anchored to the sea floor. The module is additionally usable as an electrified reef to accelerate mineral deposits on the beams that encourages marine life and increases the effectiveness of the wave barrier.

### RELATED APPLICATIONS

This application claims the benefit under 35 U.S.C. § 119(a) and the Paris Convention of patent application GB2110232.2, filed on Jul. 15, 2021 in the Intellectual Property Office of the United Kingdom, and patent application GB2209302.5, filed on Jun. 24, 2022, also filed in the Intellectual Property Office of the United Kingdom, the contents of each of which are incorporated by reference in their entireties.

### BACKGROUND OF THE INVENTION

This invention relates to an artificial reef for coastal protection.

Coastal erosion is a growing concern in many communities, with the rise of sea levels being accelerated by climate change and the power of waves also increasing. Artificial reefs formed by submerging large concrete structures or similar breakwaters are one of many techniques for protecting coastlines. Reefs (both natural and artificial) provide coastal protection because they help to dissipate or attenuate waves before they reach the shore. WO2020/212431A, for example, describes submerged breakwaters comprising base members of different shapes having hollow elongate members that attenuate wave energy and also encourage marine life.

An effective artificial reef extends from the sea floor to close to the mean sea level and provides a barrier to incoming waves. The barrier may be a solid wall, but is more usually porous to absorb some wave energy rather than completely blocking or reflecting it. Wave dissipation is most important near the surface of the water, where the waves are strongest.

An electrified or electric reef is an artificial reef made by submerging a metal frame in seawater and passing an electrical current through it. The frame serves as the cathode of the electrical circuit and dissolved minerals in the seawater, such as calcium carbonate, are deposited onto the frame. Techniques for creating electrified reefs are well established and are described, for example, in U.S. Pat. No. 5,543,034A.

The primary benefit of electrified reefs is in attracting sea-life and accelerating the growth of corals. They encourage healthy and resilient marine ecosystems and are useful for tourism. The frames are constructed based on decisions such as ease of fabrication and installation, variations in shape to encourage different marine species, and aesthetic appeal to dive tourists.

A potential secondary benefit of electrified reefs is to provide an artificial reef for coastal protection. However, the use of electrified reefs in coastal protection is limited because the frames are typically flimsy structures. They cannot withstand sufficient loads to be used to dissipate significant amounts of wave energy and are therefore typically low-lying structures that do not extend far above the sea floor. They are also often formed as very open structures that are too porous to provide a significant barrier to oncoming waves.

U.S. Pat. No. 5,543,034A suggests one solution to this problem by describing a coastal defence structure comprising layers of cathode mats interspersed with layers of rock or coral. Cementation of the layers over time further stiffens and firms the structure. Unfortunately, such a complex and heavy structure would be difficult to install.

US2011/0192352A describes a coral cultivation structure comprising a steel frame formed from a plurality of straight rods attached to a plurality of semi-circular arcs. Coral growth substrates are attached to the frame, and the frame and substrates together act as a cathode in an electrodeposition system.

What is needed is an artificial reef, and optionally an electrified reef, that is easy and safe to install and is effective at dissipating energy from the strongest waves near the surface of the water.

Securing artificial reefs and other underwater structures to the sea floor is important, especially when the underwater structure will be subjected to heavy loads from passing waves. The structure in the above-mentioned US2011/0192352A is anchored by placing rocks on flat plates or a mesh attached to the bottom of the frame. This is simple in theory, but requires the transportation and placement of large quantities of heavy rocks or weights.

Burying an anchor under a sandy bed would reduce the need to transport and place heavy weights. For example, U.S. Pat. No. 6,311,68 describes a mooring device suitable for anchoring marine vessels or buoys comprising a mushroom shaped anchor having a hollow shank. A pipe is passed through the hollow shank when it is desired to embed the anchor in sand or mud. Air or water is pumped through the pipe to loosen the sand or mud so that the anchor can settle downwards. The pipe is then removed.

What is needed is a lightweight but effective anchor that is suitable for securing underwater structures to a sandy bed by a team of divers working underwater.

Electrified reefs are typically made from steel. U.S. Pat. No. 5,543,034A also suggests titanium, titanium alloys, carbon, graphite and iron as other suitable cathode materials. Cheaper and more sustainable construction materials would be preferable.

### SUMMARY OF THE INVENTION

According to the invention, there is provided an artificial reef module comprising an arch having a roof and two side walls, the module formed as a skeletal framework having a plurality of spaced apart transverse beams, each transverse beam defining a portion of the roof and side walls of the arch, and a plurality of longitudinal beams attached to the transverse beams, each longitudinal beam extending the length of the module substantially perpendicular to the transverse beams, wherein a transverse beam at each end of the module covers the ends of the longitudinal beams.

Embodiments of the present invention provide a lightweight module for constructing an artificial reef design, that is easy to transport and safe to install thanks to the transverse beams at each end of the module covering the ends of the longitudinal beams to avoid sharp edges. The skeletal framework further provides a surface that supports mineral accretion, particularly when the module is powered for use as an electrified reef.

Preferably, the longitudinal beams are spaced apart to provide a porosity of around 40% to 60% or, when the module is to be used as an electrified reef and a build-up of minerals and corals on the surface of the frame is expected, to provide an initial porosity of around 80% to 90% with the expectation that the porosity will decrease to useful levels within 6 to 18 months. A target porosity of around 15% can be reached within 2 years. The design of transverse beams supporting longitudinal beams ensures that the module has sufficient strength to withstand hydrodynamic loads and provides a barrier to waves.

Build-up of minerals can be accelerated by laying a sheet of metal mesh material over the load-bearing arch. Advantageously, the transverse beams at each end of the module can also cover the ends of such a metal mesh to avoid sharp edges.

Preferably, the longitudinal beams are more closely spaced near to the roof of the arch to provide a lower local porosity near to the roof of the arch. The strongest waves are closest to the surface of the water, so providing a varying local porosity maximizes the effectiveness of the module as a wave barrier without adding unnecessary weight.

In one embodiment, each transverse beam at each end of the module has a C-shaped profile to envelope the ends of the longitudinal beams and any overlaying metal mesh. This ensures that the modules are safe to install and to explore by divers while also providing structural strength.

In one embodiment, at least one transverse beam has a flat surface to which the longitudinal beams are attached. Typical artificial reefs are made from lengths of rebar or other tubular beams. A flat surface, preferably at least 2 cm in width, on one or more of the transverse beams makes it easier to securely attach the longitudinal beams by welding. For example, at least one of the transverse beams can be an I-beam and at least one other transverse beam can be a simple flat strip. A flat strip is advantageously lighter but has less structural strength than an I-beam, so a transverse beam in the shape of a flat strip is located closer to the center of the module where structural strength is less important.

In one embodiment, a base beam provided at a base of each side wall and extending the length of the module is curved into a secondary arch. Consequently, the module is able to stand on a flat surface with only four points of contact with the flat surface. As well as minimizing contact with the sea floor when the module is in position on the sea floor, this secondary arch also provides a second exit from under the module for marine life and divers.

In one embodiment, the arch is a segmental arch such that the side walls of the module are not vertical. The side walls are also preferably flat. This design provides a sturdy structure, resistant to loads, as well as enabling the modules to be stacked.

In one embodiment, the reef module is an electrified reef module that gains a deposit of minerals on its surface in use over time, decreasing the spacing between the longitudinal beams. In this way, the effectiveness of the module at dissipating wave energy increases over time.

In one embodiment, the transverse beam at each end of the module has a flat surface facing out from the ends of the module (i.e., the surface is substantially perpendicular to the longitudinal beams) and near to each end of each transverse beam at each end of the module is an attachment point comprising a hole passing through the flat surface. These attachments points can be used to connect anchors for securing the module to the sea floor and/or to bolt together or otherwise connect adjacent modules when constructing an artificial reef from several modules.

Another aspect of the present invention provides an artificial reef comprising a plurality of reef modules as described above. An extensive and protective reef can be constructed from a number of identical or nearly identical modules, simplifying construction and installation.

In one embodiment, the reef module is constructed from a plurality of identical modular reef components, each modular reef component comprising a plurality of transverse beam portions that are connected together to form the plurality of transverse beams. In this way, a large reef module that might not be easily transportable in one piece can be easily constructed from multiple smaller pieces in situ.

In another aspect, the present invention provides a modular reef component adapted to be connected to one or more identical modular reef components to form an artificial reef module as described above.

Another aspect of the present invention provides an anchor for securing an underwater structure to a sandy bed, the anchor comprising a shank and an anchor head attached to a distal end of the shank, wherein a connection point is provided at a proximal end of the shank, the anchor being fixable to the underwater structure via the connection point such that the anchor is rotatable relative to the underwater structure around a horizonal axis through the connection point, and wherein the anchor has an internal conduit, the conduit having an inlet at or near the proximal end of the shank and an outlet at or near the distal end, the outlet directed in a direction substantially perpendicular to the shank and directed substantially vertically downwards when the anchor is laying on the sandy bed with the shank substantially horizontal and wherein, in use, a fluid pumped into the conduit via the inlet is expelled from the outlet to displace sand such that the anchor sinks into the sand by rotating around the connection point. Such an anchor is extremely useful in attaching a wide range of different underwater structures, such as artificial reefs, to a sandy sea floor. The fluid is conveniently air and may be delivered into the conduit from a compressed air cylinder.

In one embodiment, the conduit passes through the anchor head and a hole in a base of the anchor head is provided with a baffle to direct fluid substantially vertically downwards.

In another aspect, the present invention provides an artificial reef module suitable for constructing an electrified reef, the module formed as a skeletal framework comprising a plurality of spaced apart beams, the beams arranged to provide a barrier to incoming waves in use and formed from an electrically non-conductive material provided with an electrically conductive coating.

Embodiments of this aspect of the invention increase the range of materials that can be used to construct an artificial reef module for an electrified reef. In particular, it is possible to use renewable organic materials such as bamboo for the majority of the reef's construction for decreased cost and increased sustainability.

### BRIEF DESCRIPTION OF THE DRAWINGS

Embodiments of the invention and a description of various preferred, alternative and optional features to aid understanding of the invention will now be described by way of an example only and with reference to the accompanying drawings in which:

FIG. 1 illustrates a typical electrified reef frame known from the prior art;

FIG. 2 illustrates an artificial reef module of one embodiment of the present invention;

FIG. 3 illustrates an alternative shape for the module, with extended side walls;

FIG. 4 is a detail view of the module, illustrating the transverse and longitudinal beams;

FIG. 5 illustrates an artificial reef formed by a plurality of modules;

FIG. 6 illustrates a stack of modules for storage or transport;

FIG. 7 is an illustrative cross-section of alternating stacked modules;

FIG. 8 illustrates a module having anchors for securing it to the sea floor;

FIG. 9 illustrates an anchor;

FIG. 10 is another view of the anchor;

FIG. 11 illustrates the anchor sinking in a sandy sea floor;

FIG. 12 illustrates a module with anchors secured in a storage position;

FIG. 13 illustrates a module with anchors secured in an anchored position;

FIG. 14 illustrates an artificial reef comprising a plurality of anchored modules;

FIG. 15 illustrates a modular reef component for constructing an artificial reef module;

FIG. 16 illustrates four of the modular reef components of FIG. 15 assembled into an artificial reef module;

FIG. 17 illustrates an artificial reef constructed from a plurality of modular reef components; and

FIG. 18 illustrates an alternative arrangement of modular reef components.

### DETAILED DESCRIPTION OF THE INVENTION

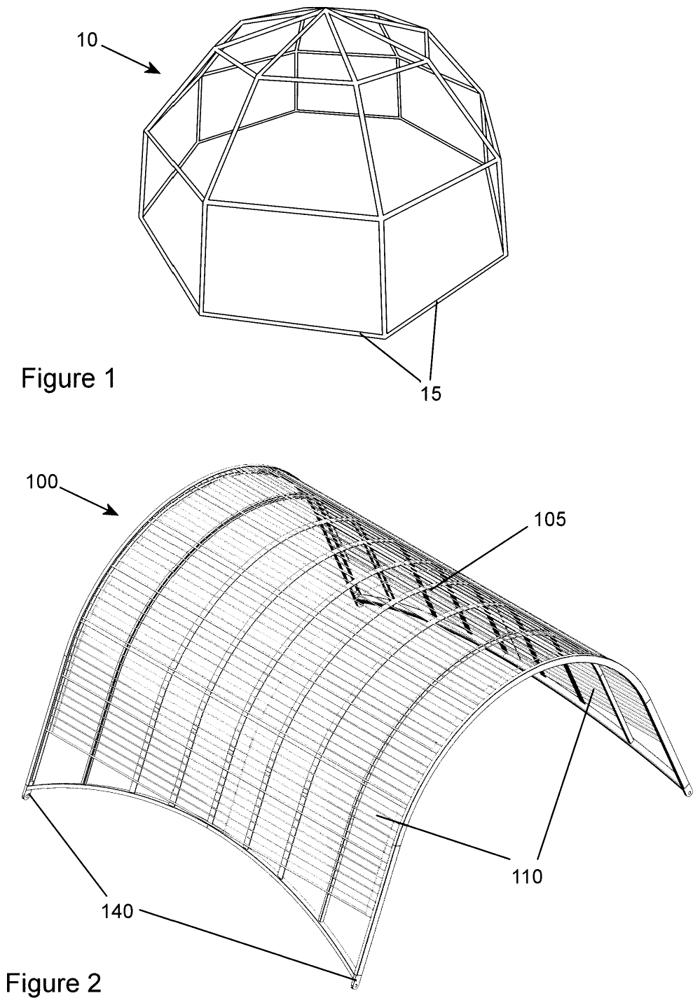

A typical frame 10 known in the prior art for creating an electrified reef is illustrated in FIG. 1. The frame 10 is a skeletal low dome formed from metal bars, typically steel rebar, welded or tied together. Advantageously, the frame 10 is quick to fabricate and sufficiently light to be installed by a small team of divers without heavy lifting machinery. In general, however, such structures are flimsy and unable to withstand the force of large waves. They also have an open structure that would not, in any event, dissipate much energy from incoming waves.

The frame 10 may be secured to the sea floor by providing the dome with a mesh floor (not shown) and filling the dome with ballast to weigh it down. Alternatively, bars 15 around the base of the frame 10 may be bolted to the sea floor.

An example of an artificial reef module 100 embodying the present invention is illustrated in FIG. 2. In this example, the module 100 is a skeletal framework generally in the shape of a straight continuous arch or tunnel having an arcuate roof 105 and two substantially straight side walls 110 at either side of the arch. The arch is segmental, with the arc of the roof 105 subtending an angle less than 180°, such that the side walls 110 of the module 100 are not vertical. The module 100 is rectangular from a plan view, between 2 m and 3 m wide at its base (the maximum distance between the two side walls 110) and between 2 m and 4 m long along the tunnel.

Other shapes of module than the one illustrated in FIG. 2 are contemplated and a module's overall size and shape can be adjusted depending on local conditions. For example, the side walls need not be straight such that the arch is arcuate over its full height. For example, the arch may be in the shape of a sector of a circle or an ellipse subtending an angle less than or equal to 180°. In another alternative, the shape of the module as seen in plan view may be a curved shape rather than a rectangle if, for example, it is necessary for the artificial reef to go around a bend rather than being a straight line.

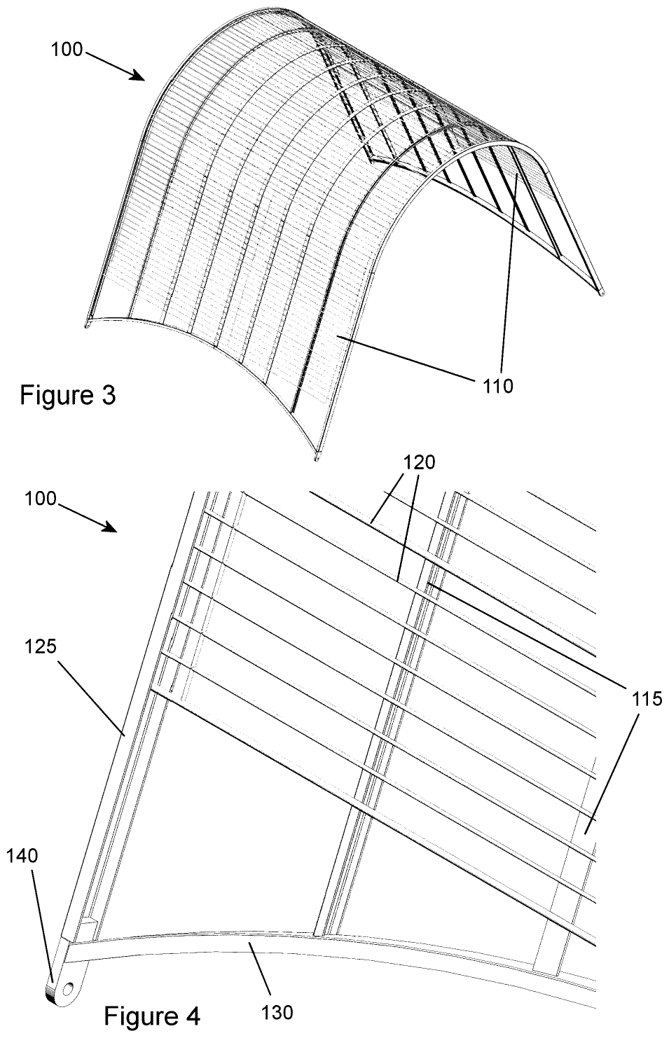

The maximum height of the arch is typically at least 2 m, and can be increased to as much as 10m in height by extending the side walls 110, as illustrated in FIG. 3. The height of the module is selected based on the depth of the sea at the intended position for the module. To effectively dissipate the strongest waves near the surface of the water, the module should be at least two thirds the height of the water at Lowest Astronomical Tide (LAT) and designed to withstand much greater loads than existing skeletal frameworks such as the frame 10 of FIG. 1. A module as illustrated in FIGS. 2 and 3 is typically suitable for use at depths of up to 10 m and can be readily installed by a team of divers without using heavy lifting equipment.

The module 100 is formed as a skeletal frame comprising a plurality of beams. As best shown in the detail view of FIG. 4, the beams include a plurality of spaced apart transverse beams 115 that are each shaped to form a portion of the continuous arch, and a plurality of spaced apart longitudinal beams 120 attached to the transverse beams 115. The longitudinal beams 120 extend the length of the module 100 along the surface of the arches defined by the transverse beams 115. The longitudinal beams 120 are generally straight and substantially perpendicular to the transverse beams 115. The beams 115,120 may have a circular cross-section, or a square cross-section, or may be substantially flat strips, or may be any other suitable shape depending on weight and strength considerations. Solid beams are preferred to hollow beams since enclosed hollow spaces in an electrified reef would not build up a layer of minerals which provide long term protection from corrosion. Each transverse beam 115 and longitudinal beam 120 may be formed as a single piece or may be formed from separate pieces joined in any suitable manner. For example, separate pieces of metal may be welded together to form each longitudinal beam 120 to obtain the desired length.

At each end of the module 100 is a transverse end beam or cap beam 125 that provides a protective cap or cover to the ends of the longitudinal beams 120. Each end beam 125 has a C-shaped profile or other suitable shape to envelope the ends of the longitudinal beams and prevent sharp edges at each end of the module 100. A metal mesh may be laid over the arch when the module 100 is to be used in an electrified reef and a C-beam or other cap beam 125 can also cover sharp edges on this mesh.

At the base of each of the side walls 110 is a longitudinally extending base beam 130. Each base beam 130 is arcuate rather than straight, providing a secondary arch so that each base beam 130 only touches the ground or sea floor at the four corners of the module 100. This limits damage to the sea floor when the module is in position, as well as providing a secondary opening for marine life and divers. The secondary arch preferably has a height of approximately 30 cm.

In use, the four corners at the base of the module 100 serve as anchor points 140. The module 100 can be secured to the sea floor via these anchor points 140 by any suitable means. Preferred anchoring methods are described below.

Most of the structural strength in the module 100 is provided by the cap beams 125 and base beams 130, and these beams are thicker or otherwise stronger than other beams in the module 100. These arching beams efficiently transfer loads to the anchor points 140 at the base of the module 100. Advantageously, each transverse beams 115 can be progressively thinner and lighter from the ends of the module towards the middle. For example, the transverse beams 115 near to the edge of the module 100 may be C-shaped or I-shaped in cross-section for increased strength, whereas the transverse beams 115 near the center of the module 100 may be flat strips to minimize weight. This reduces the overall weight of the module without compromising structural strength. Additionally, a gradient in structural strength between the middle and the ends of the module 100 allows more of the load to be transferred closer to the anchor points 140, reducing torsional moments on the base beams 130.

Alternatively, or in addition, the spacing between the transverse beams 115 can be increased closer to the center of the module to vary the strength of the structure along the length of the module 100. This avoids the complexity of having to fabricate a range of different shapes of transverse beams 115.

The flanges of the C-beams and I-beams and the flat surface of the flat strips follow the surface of the arch. Advantageously, the transverse beams 115 then provide a substantially flat surface for attaching the longitudinal beams 120, rather than being tubular beams or lengths of cylindrical rebar that have historically been used to fashion electrical reefs due to their ubiquity. This improves lateral stability and permits the use of longer welds, e.g. 2 cm to 3 cm, to secure the longitudinal beams 120 in place.

The longitudinal beams 120 provide some structural strength to the module 100, but primarily serve as a barrier to waves when the module is in position on the sea floor. They can therefore be thinner and lighter than the transverse beams 115 and are also relatively more closely spaced to provide an effective barrier to waves passing over the module. The thickness of the longitudinal beams 120 and the spacing between them is adjusted to provide a desired porosity to waves. Porosity is the fraction of the surface of the arch that comprises open space between beams 115, 120. In general, the spacing between the longitudinal beams 120 should be roughly equal to the diameter or width of each beam to provide a porosity of around 40% to 60%. This provides the appropriate porosity to attenuate waves without subjecting the module 100 or, in particular, the transverse beams 115, to too much load.

A desired porosity can be selected depending on local wave conditions. For example, if the waves are expected to be very strong, the porosity may be increased to avoid risking damage to the module 100 while still attenuating the waves. Alternatively, if it is possible to fabricate and install a heavier, stronger module 100, then the porosity may be reduced to dissipate as much wave energy as possible.

The spacing of the longitudinal beams 120 may be varied depending upon their position on the module 100. This enables the module 100 to maximize its potential to dissipate wave energy at a minimum weight. The energy in a wave is greatest near the surface of the water and decays exponentially with increasing depth. The spacing of the longitudinal beams 120 can be adjusted correspondingly so that the spacing is smallest at or near the top of the module 100 and increases towards the bottom. The desired spacing can be selected based on wave conditions and a maximum load that the module 100 is able to withstand. Larger open spaces can also be provided at one or more different heights to allow free movement of fish.

Advantageously, the thickness of the longitudinal beams 120 may also be varied over the surface of the arch. At regular intervals, a slightly thicker longitudinal beam 120 can be provided to increase structural stability. This thicker longitudinal beam 120 can also be welded to every transverse beam 115 to make a secure connection whereas intervening thinner longitudinal beams 120 may be welded only at alternate crossing points to reduce the number of welds without significantly affecting overall structural strength.

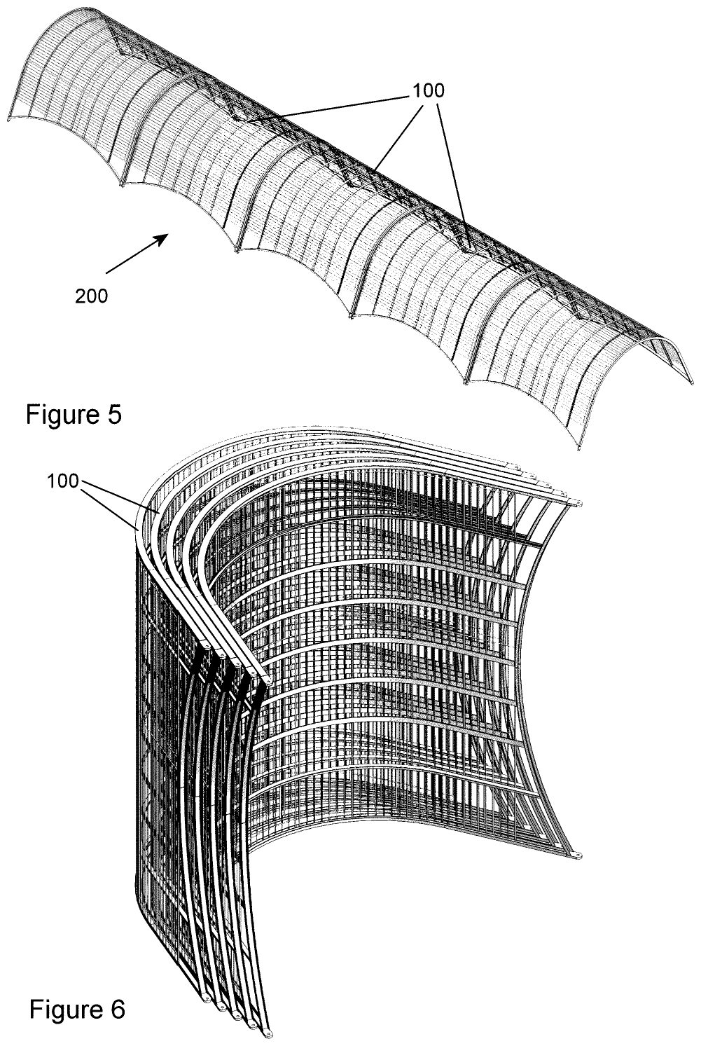

In use, a plurality of modules 100 are used to create an artificial reef 200, as illustrated in FIG. 5. Advantageously, a large reef 200 can be constructed from an array of smaller modules 100. The modules 100 may be connected to each other in reef sections of any desired length by any suitable method. For example, the end beams 125 of each module 100 and/or the anchor points 140 may be provided with bolt holes used to bolt adjacent modules 100 together. Where the end beams 125 are C-beams, these holes are provided in the connecting web of the C-beam. Connection of the modules 100 is therefore simple enough to be done in situ on the sea floor. Sections of reef 200 may also be constructed on land, in shallow water or on a boat and then moved into position to minimize underwater work. Buoyancy aids may be attached the modules 100 to aid in moving the modules 100 through the water. Due to their skeletal construction, and with further optimizations for weight as discussed above, each module 100 is light enough to be installed by a small team of divers without the use of heavy machinery. The artificial reef 200 can extend roughly parallel to a shoreline to provide extensive protection. The artificial reef 200 mimics the wave attenuation properties of natural coral and oyster reefs, breaking large waves before they reach the shore, and restoring sediment onto beaches.

To create a long reef 200, a large number of modules 100 are required. It is therefore important to be able to store or transport modules 100 efficiently. As illustrated in FIG. 6, the segmental arch shape of each module permits several modules 100 to be stacked in a space-saving manner with each arch fitting inside the arch of an adjacent module 100. Also, the rectangular plan outline of each module 100 with flat ends means that each module 100 or a stack can be stored or transported on its side.

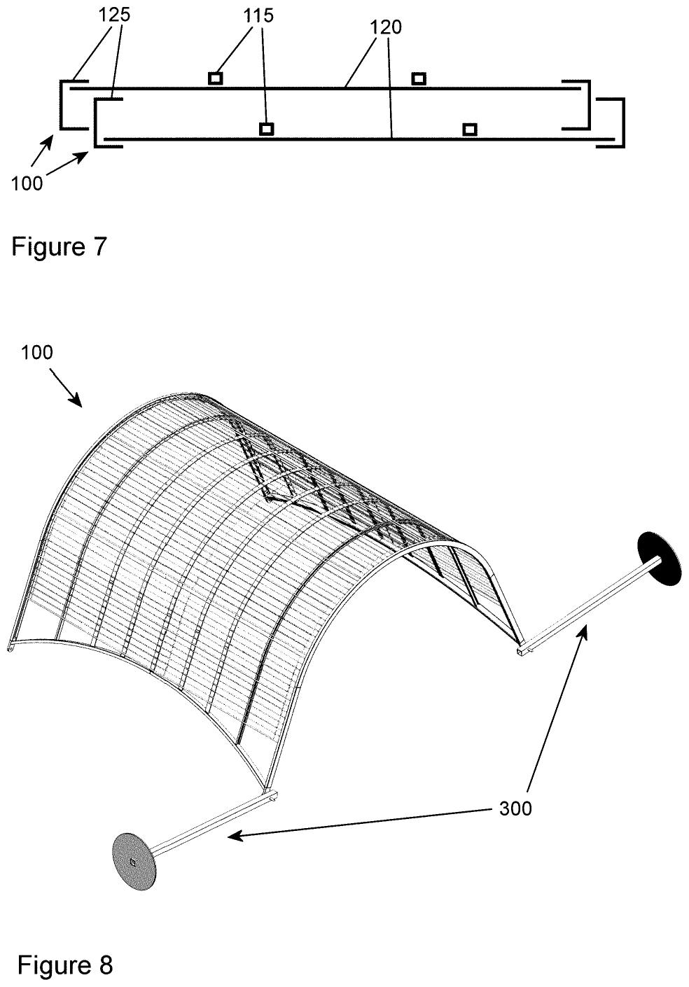

To further increase the compactness of the stacking, half of the modules 100 can be formed so that the longitudinal beams 120 are connected to one side of the end beams 125 (for example, against one flange of the C-shaped profile) and the other half have the longitudinal beams 120 connected to the other side of the end beams 125. Adjacent modules 100 in a stack can be alternate types of module 100 and offset slightly so that they fit together in a compact arrangement. This is depicted in FIG. 7, which is an illustrative cross-sectional view through two alternating stacked modules 100.

The ability to stack the modules 100 may also be used when the modules 100 are used to make a reef 200. Several modules 100 may be stacked to increase the overall height of the reef 200 to adapt to varying water depth without needing to manufacture modules 100 of different heights.

The module 100 is most conveniently made from steel or some other suitable electrically conductive metal. It is also possible to form the module 100 from any suitable non-conductive material and to coat it with an electrically conductive material such as a carbon-containing paint. Alternatively, or in addition, an electrically conductive sheet made from a metal mesh such as expanded metal mesh or chicken wire, can also be laid over and attached to some or all of the module 100. These and other suitable methods for making the module electrically conductive enable the module 100 to be used as part of an electrified reef. Electrification of the reef 200 may be achieved by any suitable technique such as connecting the modules to a source of electrical energy or to a sacrificial anode. Conveniently, a nearby wave-energy extraction device such as described in WO2012150437 can be used to power the electrified reef.

Advantageously, when used in an electrical reef, the spacing of the longitudinal beams 120 on each module 100 may be greater than would otherwise be required to provide the desired porosity to incoming waves. As minerals precipitate on the beams 115, 120 and as coral grows, the beams increase in size, reducing the porosity of each module 100 and the reef 200 as a whole over time. This enables lightweight modules 100 to be installed with the expectation that they will reach full effectiveness later. Similarly, a metal mesh placed over a high porosity, but sufficiently load-bearing, base structure can also be used to accelerate mineral accretion while minimizing weight. Optionally, the initial porosity of the module 100 may be as high as 80% or 90% to minimize the weight and cost of the module 100.

To mitigate the initially larger porosity of an electrified reef, a temporary, non-porous surface such as a plastic sheet can be attached to each module 100 to ensure that the reef 200 has an immediate wave dissipating effect. This temporary surface can be removed once sufficient mineral accretion and other growth has occurred, which may take 6 to 18 months from installation. The temporary surface can then be reused on another module 100 when installing a new reef 200 or extending an existing reef. Temporary surfaces, and also any overlaying metal mesh, preferably has gaps to allow free movement of fish.

To form a reef 200, modules 100 can be secured to the sea floor via their respective anchor points 140 using any suitable technique such as attaching ballast or driving bolts into solid rock. Preferably, however, some or all of the modules 100 are provided with one or more sand anchors 300, as illustrated in FIG. 8.

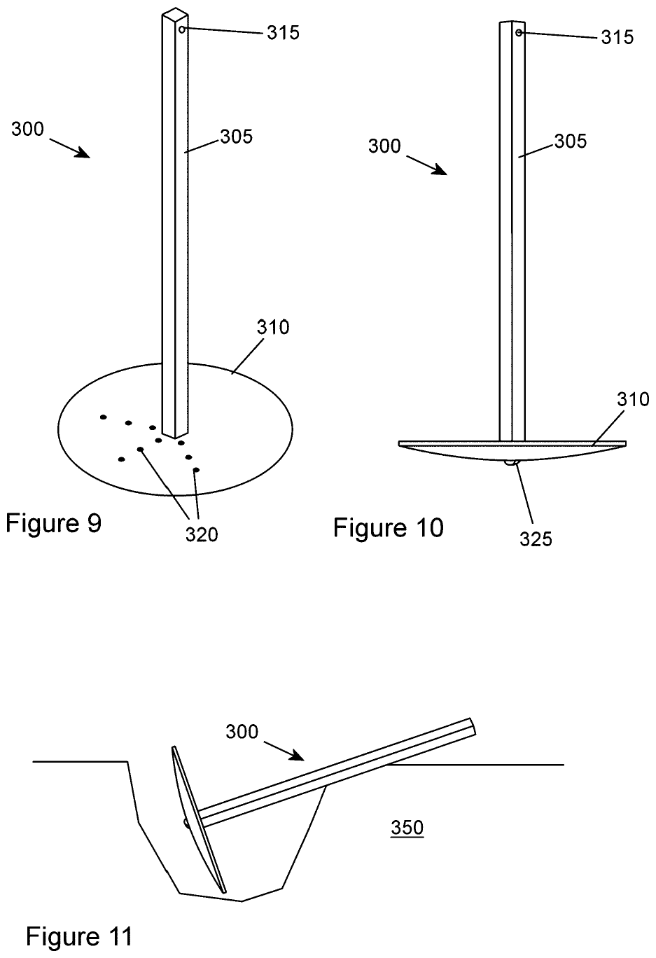

An anchor 300 is illustrated in more detail in FIGS. 9 and 10. The anchor 300 includes a shank or leg 305 and an anchor head comprising an anchor plate 310 connected to a distal or bottom end of the leg 305. The leg 305 is illustrated as having a square cross-section but may have other cross-sections such as circular. The anchor plate 310 is illustrated as having a circular outline, but the outline may instead be elliptical, square, polygonal or any other suitable shape. The perimeter of anchor plate 310 has a thin edge to enable it to dig into sand or other particulate matter on the sea floor as illustrated in FIG. 11.

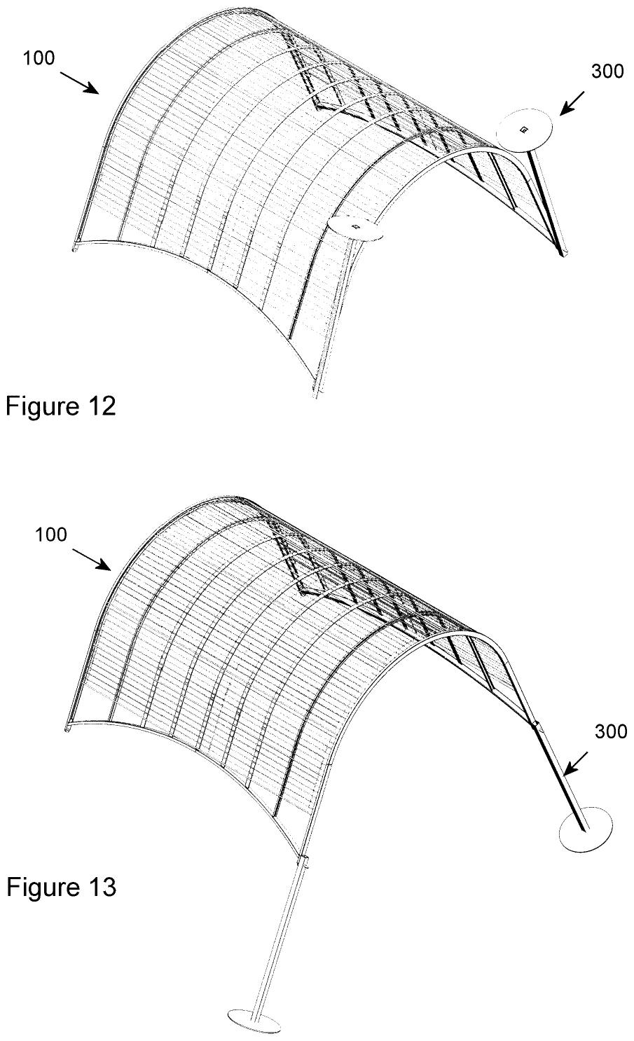

A proximal or top end of the leg 305 is connected to a module 100 by, for example, a bolt passing through a hole 315 near the proximal end and into a corresponding hole in an anchor point 140 of the module 100. The anchor 300 is connected so that it is able to rotate relative to the module 100 about a horizontal axis, parallel with the longitudinal axis of the module 100. The anchor plate 310 at the distal end of the leg 305 can therefore be moved up and down by rotating the anchor 300. One or more lock stops (not shown) on the leg 305 restrict the range of rotation between a stored position where the anchor plate 310 is raised (as illustrated in FIG. 12) and an anchored position where the anchor plate 310 is lowered (as illustrated) in FIG. 13. The or each lock stop also enables the anchor 300 to be locked into these positions. In particular, locking the anchor 300 in the stored position is important for safety so that the anchor does not fall on a diver while the module is being installed.

The leg 305 is hollow, having an internal conduit that extends from an inlet (not shown) at or near the proximal end of the leg 305, along the length of the leg 305, through the anchor plate 310, to an outlet (not shown) on the far surface of the anchor plate 310. The inlet may be provided by leaving the proximal end of the leg 350 open, or a separate inlet hole may be provided near the proximal end and closing the proximal end of the leg 350. The outlet is partially covered by a baffle 325 in the shape of a half dome so that fluid passing out of the outlet is redirected at 90° to the leg 305, parallel to the surface of the anchor plate 310. Additional outlets may also be provided along the length of the leg 305.

Optionally, the anchor plate 310 is also hollow and the conduit through the leg 305 is in fluidic communication with the hollow interior of the anchor plate 310. In this arrangement, a surface of the anchor plate 310 facing the leg 305 is provided with a plurality of holes 320 opening into the hollow interior of the anchor plate 310.

In use, when the anchor is resting on a sandy sea floor 350 (as illustrated in FIG. 11), a fluid such as air or a mixture of air and water are pumped into the inlet in the leg 305. The inlet may be provided with a connector to connect the inlet to a source of compressed air. The fluid escapes through the outlet at the end of the leg 305 and is redirected by the baffle 325 downwards towards to the sea floor 350. This disperses sand, enabling the anchor plate 310 and lower end of the leg 305 to sink in the sea floor 350 without extensive digging. The fluid also escapes through any holes in the leg 305 or the holes 320 in a hollow anchor plate 310, which also disperse sand around the anchor 300.

Alternatively, or in addition, a vibrating device (not shown) is attached to a lower end of the leg 305 and/or the anchor plate 310. The vibrations are imparted to the anchor 300 which again helps to disperse sand so that the anchor 300 sinks into the sea floor 350. A cable attached to the vibrating device enables it to be retrieved from under the sand once the anchor 300 is in place.

In the stored position, the anchors 300 are rotated so that the leg 305 extends generally upwards from its anchor point 140 on the module, conveniently keeping it away from the ground. It is therefore possible to easily and safely move the module 100 while the anchor 300 is attached. The anchor 300 can therefore be attached to the module 100 on land or in shallow water to reduce the amount of underwater work required.

Once the module 100 is in position on the sea floor, the anchor 300 can be unlocked and rotated into a mid-position illustrated in FIG. 8. In the mid-position, the leg 305 is substantially horizontal and the anchor plate 310 is resting on the sea floor. The anchor 300 can then be sunk into the sandy sea floor as described above and will continue to rotate towards the anchored position.

In the preferred anchored position, the leg 305 is substantially parallel to the side wall 110 adjacent the anchor point 140 to which the anchor 300 is attached for optimal stability. The leg 305 can then be locked into this position. Solid obstacles under the sea floor, such as large rocks, may prevent the anchor 300 from reaching the preferred anchored position, but the anchor 300 is still effective at securing the module 100 to the sea floor even when only partially submerged in sand.

Anchors 300 can be attached to one, some or all of the four anchor points 140 on a module. For greatest security, four anchors 300 per module 100 are preferred.

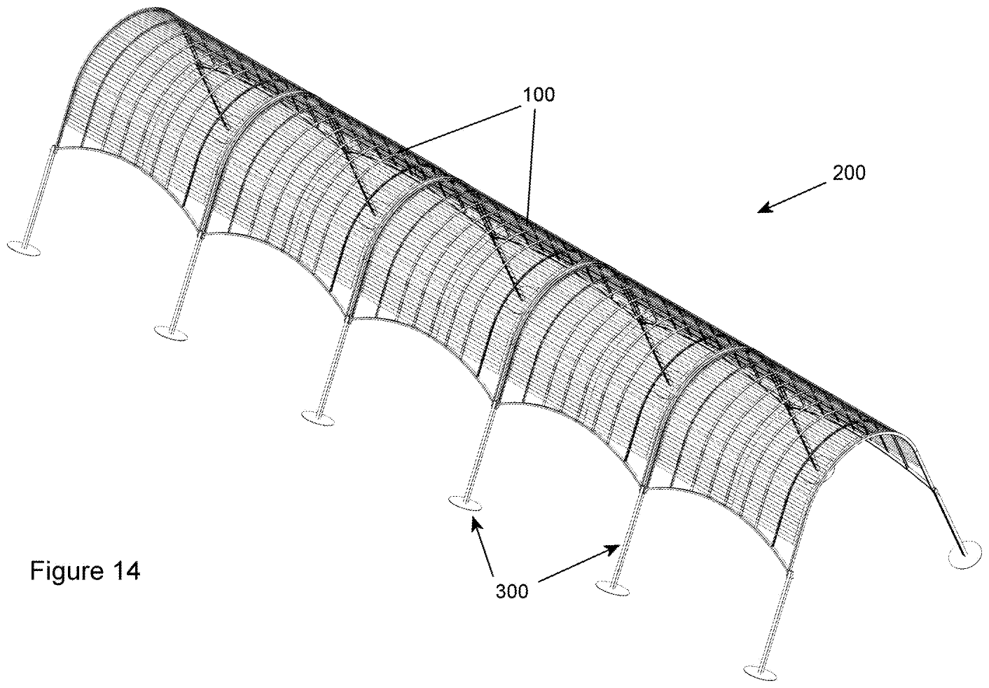

When a plurality of modules 100 are arranged in a reef 200, anchors 300 are preferably attached between adjacent modules as well as at each end of the reef 200, as illustrated in FIG. 14. Advantageously, a single anchor 300 can attach to two anchor points 140 on adjacent modules, significantly reducing the number of anchors 300 required for long reefs 200.

In some situations, such as when installing an artificial reef in very deep water, a reef module 100 may be required that is larger than can be conveniently or safely moved by a team of divers without heavy lifting machinery. For example, a reef module 100 may be too large to move manually if it has a height of more than around 10m.

In such situations, the reef module 100 may be manufactured in sections. For example, the roof 105 and each of the two side walls 110 may be constructed as separate pieces. These separate, smaller and lighter pieces can more easily be transported manually and assembled on site by bolting or otherwise securely joining them together.

One disadvantage of this approach is that having a number of differently shaped pieces may cause confusion and make the task of assembling the module while in the water more difficult. It would be convenient to have a reef module that can be constructed from several identical pieces

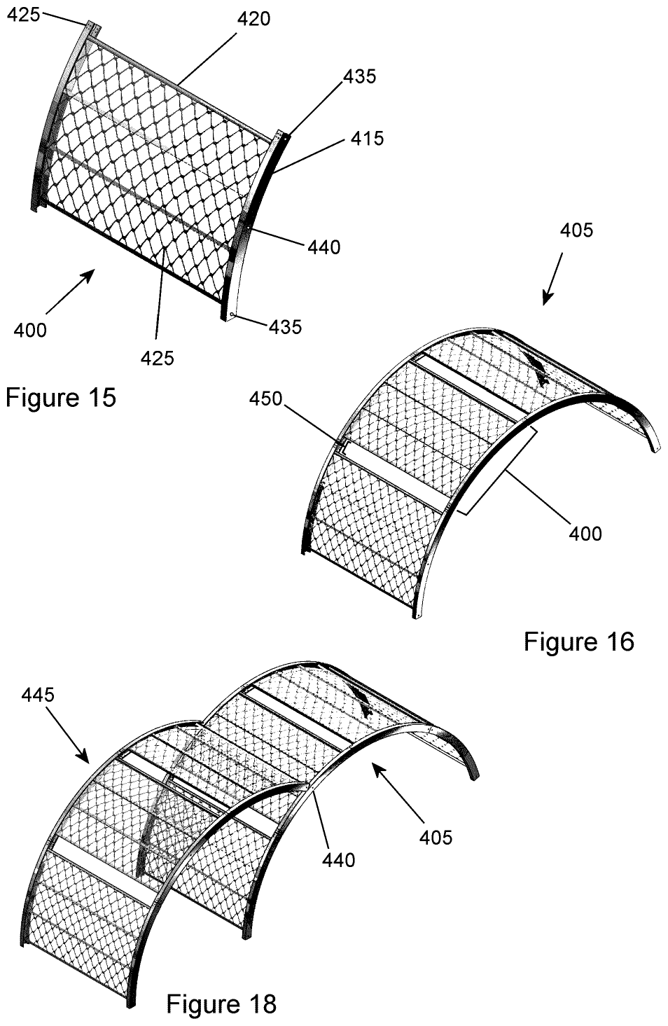

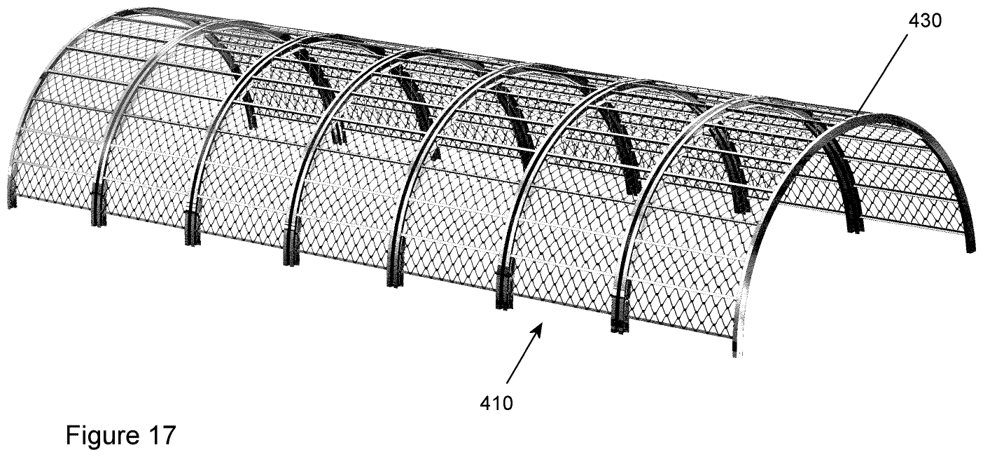

A modular reef component 400 is illustrated in FIG. 15. Two or more identical modular reef components 400 can be assembled on site into a reef module 405 as illustrated in FIG. 16. Multiple such reef modules 405 can be connected together to form an artificial reef 410 of a desired length as illustrated in FIG. 17.

In profile, the modular reef component 400 is curved in the shape of a sector of a circle. The angle subtended by the curve depends upon the number of modular reef components 400 that are required to make a reef module 405 and the desired shape of the reef module 405. In the non-limiting examples illustrated in FIGS. 15 and 16, four modular reef components 400 are used to construct a reef module 405. In this example, each modular reef component 400 subtends an angle equal to 45° to construct a reef module 405 in the shape of a semi-circular arch, or less than 45° in order to construct a segmental arch. In the example illustrated in FIG. 17, only two modular reef components, each subtending an angle of approximately 90°, are used to construct each reef module, which are then joined together to create an artificial reef 410.

The modular reef component 400 comprises at least two transverse beam portions 415 and at least two longitudinal beams 420 secured to the transverse beam portions 415 by, for example, welding.

The transverse beam portions 415 correspond with the transverse beams 115 of the reef module 100 of FIG. 2 and the design considerations discussed in connection with that structure can be applied equally to the transverse beam portions 415. In particular, the two transverse beam portions 415 at each end of the of the modular reef component 400 provide a protective end cap to the longitudinal beams 420 by, for example, having a C-shaped profile.

The examples illustrated in the Figures comprise only two transverse beam portions 415 in order to make each modular reef component 400 as small and light as possible while still being able to use them to construct a large artificial reef 400.

Nevertheless, additional transverse beam portions 415 may be added between the two beams and may in the shape of I-beams or flat strips, as already discussed above in connection with the transverse beams 115 of FIG. 2.

The end of each transverse beam portion 415 has one or more attachment holes 425 for use in attaching the modular reef component 400 to an adjacent modular reef component. The attachment holes 425 are provided in the flat surfaces of the transverse beam portions 415 that are aligned with the surface of the arch. One or more flat connector plates 430 (illustrated in FIG. 17) with corresponding holes can then be bolted or otherwise connected to the ends of the transverse beam portions 415 on adjacent modular reef components 400 to connect them together. For C-shaped or I-shaped transverse beam portions 415, the connector plates 430 may be attached to both flanges, on the inner and outer surfaces of the arch, to provide an even more secure connection.

The transverse beams portions 415 at each end of the modular reef component 400, are provided with an anchor holes 435. Where the end beams 125 are C-beams, the anchor holes 435 are provided in the connecting web of the C-beam. These holes are used to bolt or otherwise secure adjacent reef modules 405 together when constructing an artificial reef 410. Optionally, intervening anchors 300 can also be secured via the anchor holes 435 at the far ends of the completed transverse beams, as discussed above in connection with FIG. 14.

The transverse beams portions 415 at each end of the modular reef component 400 are also provided with lateral extender holes 440. A single lateral extender hole 440 may be provided halfway along each transverse beams portion 415, or a plurality of lateral extender holes 440 may be arranged symmetrically along their length. As illustrated in FIG. 18, the lateral extender holes 440 are used to connect a complete reef module 405 with an adjacent incomplete reef module 445 in order to extend the artificial reef 410 in a lateral direction, as opposed to a longitudinal direction.

The incomplete reef module 445 has insufficient modular reef components 400 to form a complete arch, having one incomplete leg. The incomplete leg is leaned against the side of a complete reef module 405 aligning the anchor hole 435 at the end of the incomplete leg with a lateral extender hole 440 in the complete reef module 405. A connector plate 430 (not illustrated in FIG. 18) can then be used to connect the two modules.

The longitudinal beams 420 correspond with the longitudinal beams 120 of the reef module 100 of FIG. 2 and the design considerations discussed in connection with that structure can be applied equally to the longitudinal beams 420. In particular, the longitudinal beams 420 are spaced apart to provide a desired porosity to serve as a suitable barrier to waves.

In the example of FIG. 15, the longitudinal beams 420 are widely spaced to have a high porosity so that each modular reef component 400 is as small and light as possible. To ensure that the porosity increases rapidly as minerals build up on the surface of the artificial reef 410, a sheet of metal mesh material 425 is laid over and attached to the longitudinal beams 420.

The outermost longitudinal beams 420 are not connected right at the ends of the transverse beams portions 415 but instead have a connection point spaced away from the ends of transverse beams portions 415. As illustrated in FIG. 16, this creates a gap 450 between the longitudinal beams 420 of adjacent modular reef components 400 and, in particular, a gap in the overlying metal mesh material 425 to allow free movement of fish.

Steel and other metals are suitable materials for constructing an electrified artificial reef but require special skills and equipment to shape and weld together the beams as well as being non-sustainable and non-renewable. Instead, the skeleton frame and load-bearing structure of the reef module 100 may be constructed, at least in significant part, from a renewable material such as a natural biological material, particularly wood or, even more particularly, bamboo.

Although the foregoing description focuses on the construction of metal frames, it will be recognized that many of the design features of the reef modules described above apply to modules constructed from renewable materials. The ends of bamboo rods, for example, can be very sharp so covering or capping the ends of longitudinal beams will improve safety as discussed above.

Bamboo and other suitable renewable materials do not conduct electricity. The electrically non-conductive renewable material is therefore coated with an electrically conductive material. Suitable coatings include conductive paints or inks such as carbon-containing inks. Some conductive inks and paints use toxic solvents or precious metals such as silver and these are preferably avoided for environmental reasons.

Providing an electrically conductive coating enables natural electrically insulating materials to be used in the construction of an electrified artificial reef. The electrochemical formation of minerals or bio-rock on the surface of such materials offers a sustainable, resilient, and affordable alternative to steel. The coating also protects the natural materials from biodegradation before a layer of minerals has developed. In contrast, steel artificial reefs are subject to corrosion until a protective layer of minerals has developed.

Bamboo is a particularly advantageous material for constructing a reef module 100. It is low cost, low weight, and its tubular geometry means that large diameter bars reach the same strength as steel. Using large diameter bars results in an initial structure porosity of around 30% to 40% while still being light enough to deploy easily. This reduces the time to achieve a typical target porosity of 15% from 2 years for an equivalent steel structure to around 4 months.

For bamboo rods and other hollow construction materials, the coating may be sprayed only onto the outer surface for cost and simplicity. Water accessible internal surfaces are then subject to biodegradation when submerged. The ends of hollow tubes may be filled to prevent this but, in some environments, the build-up of a mineral layer will provide sufficient additional strength to the structure as the biological parts degrade. Alternatively, the internal surfaces may also be coated by, for example, dipping the bamboo rods into a large vat.

The following numbered clauses provide a non-limiting summary of advantageous features of the reef module and anchors described in detail above.

Clause 1. An anchor for securing an underwater structure to a sandy bed, the anchor comprising a shank and an anchor head attached to a distal end of the shank, wherein a connection point is provided at a proximal end of the shank, the anchor being fixable to the underwater structure via the connection point such that the anchor is rotatable relative to the underwater structure around a horizonal axis through the connection point, and wherein the anchor has an internal conduit, the conduit having an inlet at or near the proximal end of the shank and an outlet at or near the distal end, the outlet directed in a direction substantially perpendicular to the shank and directed substantially vertically downwards when the anchor is laying on the sandy bed with the shank substantially horizontal, and wherein, in use, a fluid pumped into the conduit via the inlet is expelled from the outlet to displace sand such that the anchor sinks into the sand by rotating around the connection point.

Clause 2. The anchor of Clause 1 wherein the conduit passes along the shank and through the anchor head and a hole in a base of the anchor head is provided with a baffle to direct fluid substantially vertically downwards.

Clause 3. The anchor of Clause 1 or Clause 2 wherein the fluid is air.

Clause 4. An artificial reef module suitable for constructing an electrified reef, the module formed as a skeletal framework comprising a plurality of spaced apart beams, the beams formed from an electrically non-conductive material provided with an electrically conductive coating.

Clause 5. The reef module of Clause 4 wherein the electrically non-conductive material is a renewable organic material.

Clause 6. The reef module of Clause 5 wherein the renewable organic material is bamboo.

Clause 7. The reef module of any of Clauses 4 to 6 wherein the electrically conductive coating is a conductive ink.

Clause 8. The reef module of any of Clauses 4 to 7 wherein the plurality of beams are arranged to provide a barrier to incoming waves in use.

Clause 9. The reef module of any of Clauses 4 to 8 wherein the skeletal framework comprises a plurality of transverse beams defining the shape of an arch having a roof and two side walls, and a plurality of longitudinal beams attached to the transverse beams and extending substantially perpendicular to the transverse beams.

Clause 10. The reef module of Clause 9 wherein a transverse beam at each end of the module covers the ends of the longitudinal beams.

Clause 11. The reef module of any of Clauses 4 to 10 wherein the beams are spaced apart to provide a porosity of between 30% and 40%.

What is claimed is:

1. An artificial reef module comprising an arch having a roof and two side walls, the module formed as a skeletal framework having a plurality of spaced apart transverse beams defining the shape of the arch, and a plurality of spaced apart longitudinal beams attached to the transverse beams, each longitudinal beam extending the length of the module substantially perpendicular to the transverse beams, wherein a transverse beam at each end of the module covers the ends of the longitudinal beams.

2. The reef module of claim 1 wherein the longitudinal beams are spaced apart to provide a porosity of between 40% and 90%, porosity being the fraction of the surface of the arch that comprises open space between the longitudinal beams, with the longitudinal beams being more closely spaced near to the roof of the arch to provide a lower local porosity near to the roof of the arch.

3. The reef module of claim 1 wherein the module is formed from an electrically conductive material and is suitable for use as an electrified reef that gains a deposit of minerals on its surface in use over time.

4. The reef module of claim 1 wherein each transverse beam at each end of the module has a C-shaped profile that envelopes the ends of the longitudinal beams.

5. The reef module of claim 1 wherein at least one transverse beam has a flat surface to which the longitudinal beams are attached.

6. The reef module of claim 1 wherein at least one transverse beam comprises an I-beam and the longitudinal beams are attached to an outer surface of one flange of the I-beam.

7. The reef module of claim 1 wherein at least one transverse beam comprises an I-beam and at least one other transverse beam comprises a flat strip.

8. The reef module of claim 1 wherein a base beam provided at a base of each side wall and extending the length of the module is curved into a secondary arch.

9. The reef module of claim 1 wherein the arch is a segmental arch, the roof being curved in an arc that is less than 180° and the two side walls being substantially straight and non-parallel.

10. The reef module of claim 1 wherein the module is stackable on top of a second reef module.

11. The reef module of claim 1, wherein the transverse beam at each end of the module has a flat surface facing out from the ends of the module, and wherein near to each end of each transverse beam at each end of the module is an attachment point comprising a hole passing through the flat surface.

12. The reef module of claim 11 further comprising at least one anchor attached to an attachment point.

13. An artificial reef comprising a plurality of reef modules according to claim 11, each reef module attached to an adjacent reef module via their attachment points.

14. Two reef modules according to claim 1, wherein each transverse beam at each end of each module has a C-shaped profile that envelopes the ends of the longitudinal beams, and wherein, in a first reef module, the ends of the longitudinal beams are connected to a first flange of the C-shaped profile and, in a second reef module, the ends of the longitudinal beams are connected to a second flange of the C-shaped profile, opposite the first flange, to enable close packing of the first reef module with the second reef module.

15. An artificial reef module according to claim 1 constructed from a plurality of identical modular reef components, each modular reef component comprising a plurality of transverse beam portions that are connected together to form the plurality of transverse beams.

16. A modular reef component adapted to be connected to one or more identical modular reef components to form an artificial reef module according to claim 1.

17. The reef module of claim 1, wherein the module is formed from an electrically non-conductive material provided with an electrically conductive coating.

18. The reef module of claim 17 wherein the electrically non-conductive material is bamboo and the electrically conductive coating is a conductive ink.

19. The reef module of claim 1 further comprising an electrically conductive metal mesh laid over the arch.

20. The reef module of claim 19 wherein the transverse beam at each end of the module covers the ends of the metal mesh.
